(19) United States
(12) Patent Application Publication
(10) Pub. No.: US 2010/0179076 A1
(43) Pub. Date: Jul. 15, 2010

(54) Filled Systems From Biphasic Fluids

(76) Inventors: Philip F. Sullivan, Bellaire, TX (US); Gary John Tustin, Sawston (GB); Robert Seth Hartshorne, Newmarket (GB); J. Ernest Brown, Fort Collins, CO (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/354,370

(22) Filed: Jan. 15, 2009

(51) Int. Cl. C09K 8/62

(52) U.S. Cl. 507/214; 507/273

(57) ABSTRACT

Methods and apparatus for forming a fluid for use within in a subterranean formation comprising combining a partitioning agent, crosslinkable polymer, and crosslinker into a fluid, wherein more than 50 percent of the crosslinkable polymer crosslinks and less than 10 percent of the partitioning agent crosslinks, and introducing the fluid into the subterranean formation. Methods and apparatus of forming a fluid for use within in a subterranean formation comprising combining a partitioning agent, crosslinkable polymer, and crosslinker into a fluid, wherein a critical polymer concentration for crosslinking the crosslinkable polymer is lower than if the partitioning agent were not in the fluid, and introducing the fluid into the subterranean formation.

### FIELD

The invention relates to fluid loss additives for use in oilfield applications for subterranean formations. More particularly, the invention relates to filter cakes, particularly to easily destroyable filter cakes formed from polymers.

### BACKGROUND

The statements in this section merely provide background information related to the present disclosure and may not constitute prior art.

This invention relates to fluids used in treating a subterranean formation. In particular, the invention relates to the use of water-in-water emulsions. Various types of fluids are used in operations related to the development and completion of wells that penetrate subterranean formations, and to the production of gaseous and liquid hydrocarbons from natural reservoirs into such wells. These operations include perforating subterranean formations, fracturing subterranean formations, modifying the permeability of subterranean formations, or controlling the production of sand or water from subterranean formations. The fluids employed in these oilfield operations are known as drilling fluids, completion fluids, work-over fluids, packer fluids, fracturing fluids, stimulation fluids, conformance or permeability control fluids, consolidation fluids, and the like. Stimulation operations are generally performed in portions of the wells which have been lined with casings, and typically the purpose of such stimulation is to increase production rates or capacity of hydrocarbons from the formation.

A need remains for an inexpensive and reliable well treatment fluids and for methods of use during well treatments such as well completion, stimulation, and fluids production.

### SUMMARY

Embodiments of the invention provide methods and apparatus for forming a fluid for use within in a subterranean formation comprising combining a partitioning agent, crosslinkable polymer, and crosslinker into a fluid, wherein more than 50 percent of the crosslinkable polymer crosslinks and less than 10 percent of the partitioning agent crosslinks, and introducing the fluid into the subterranean formation. Embodiments of the invention provide methods and apparatus of forming a fluid for use within in a subterranean formation comprising combining a partitioning agent, crosslinkable polymer, and crosslinker into a fluid, wherein a critical polymer concentration for crosslinking the crosslinkable polymer is lower than if the partitioning agent were not in the fluid, and introducing the fluid into the subterranean formation.

### BRIEF DESCRIPTION OF THE DRAWINGS

FIG. 1 is a sectional view of a starch filler phase and guar gum phase of an embodiment of the invention.

FIG. 2 illustrates a plot the volumetric portion of a sample occupied by a starch-rich phase as a function of the amount of waxy-maize starch added of an embodiment of the invention.

FIG. 3 illustrates the effect of the presence of the swollen waxy-maize starch on the viscosity of a guar solution of an embodiment of the invention.

FIG. 4 illustrates the minimum guar concentration to create a crosslinked fluid as a function of amount of added waxy-maize starch of an embodiment of the invention.

### DETAILED DESCRIPTION OF THE INVENTION

The procedural techniques for pumping fluids down a wellbore to fracture a subterranean formation are well known. The person that designs such treatments is the person of ordinary skill to whom this disclosure is directed. That person has available many useful tools to help design and implement the treatments, including computer programs for simulation of treatments.

In the summary of the invention and this description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific numbers, it is to be understood that inventors appreciate and understand that any and all data points within the range are to be considered to have been specified, and that inventors have disclosed and enabled the entire range and all points within the range. All percents, parts and ratios herein are by weight unless specifically noted otherwise. In this document, the terms “microsphere,” “microbead,” and “microparticle” are used interchangeably for microscopic particles, which may contain an interior void.

Two polymers, upon dissolving in a common solvent, may spontaneously separate into two phases that are each enriched in one of the polymers. When two or more different water soluble polymers are dissolved together in an aqueous medium, it is sometimes observed that the system phase separates into distinct regions or phases. The presence of these regions or phases may also be referred to as a water water emulsion. This separation happens when two polymers at high concentration are each water-soluble but thermodynamically incompatible with each other, such as polyethylene glycol (PEG) and dextran.

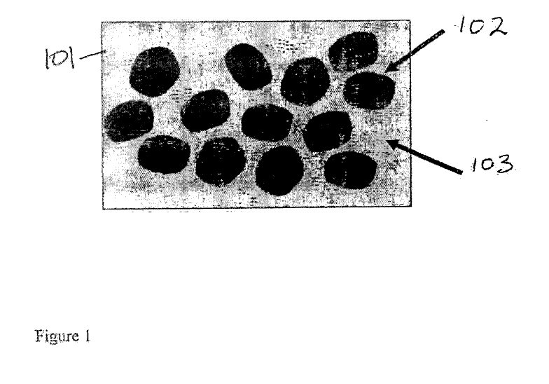

For example, FIG. 1 illustrates the concept of a starch filler phase to globally reduce the amount of guar gum needed to make a crosslinked fluid for wellbore service. FIG. 1 provides a sectional view of an emulsion 101 comprising isolated regions of high concentration of starch 102 that may be microbeads and a crosslinkable polymer continuous phase 103 comprising guar. The filler phase does not crosslink. For example, in a desirable system, the crosslinkable phase is more likely to crosslink, that is, crosslink while globally requiring less crosslinkable polymer, in the presence of the filler phase than if the filler phase is not present. In some embodiments, more than 50 percent of the crosslinkable polymer crosslinks and less than 10 percent of the partitioning agent crosslinks.

The morphology of the de-mixed “emulsion” is related to the relative concentration of the two species. Systems formed with a 50/50 phase volume condition often give rise to bi-continuous phase structures with neither phase being internal or external. Biphasic mixtures formulated away from this bi-continuous condition comprise droplets of one polymer-rich phase dispersed in an external phase enriched with the other polymer. These droplets may be of such a nature that they resemble microspheres or other shapes of consistent composition. The phase behavior and composition of a mixed system depends on the relative polymer concentrations, the interactive associations between the polymer types, and the affinity of each polymer for the common solvent. Temperature, salinity, pH, and the presence of other molecules in solution can all influence the system polymer-polymer and polymer-solvent interactions. Density differences between phases will occasionally give rise to bulk separation if left undisturbed over time.

This phase separation that arises when incompatible polymers are introduced into a system has been studied in other industries. In the food industry, two-phase aqueous fluids are used to create polymer solutions that mimic the properties of fat globules. In the biomedical industry, such systems are exploited as separation media for proteins, enzymes, and other macromolecules that preferentially partition to one polymer phase in the mixture. For example, drug encapsulation and surface modifiers may be selected that comprise water water emulsions because the nontoxic materials are charged and have moderate interfacial tension between two phases.

The oilfield service industry may benefit from biphasic polymer systems for a myriad of applications. A wellbore treatment fluid can be created by phase-separating the crosslinkable polymer in solution with a second material (possibly also a polymer) that does not participate in the crosslinking reaction or process. The crosslinkable polymer is then concentrated in its phase, and can be crosslinked in this volume even though globally the polymer concentration is well below the critical overlap concentration for crosslinking. Using this technique, crosslinked fluids can be formulated with a minimum amount of an expensive polymer or a limited amount of a damaging polymer.

The term water-in-water emulsion as used herein is used to encompass mixtures comprising normally water-soluble polymers in the dispersed phase regardless of whether the dispersed phase is a liquid droplet of low or high viscosity polymer solution, or a paste-like or water wet polymer globule containing solid polymer particles, i.e. the water-in-water emulsion is applicable to both liquid-liquid mixtures and liquid-solid slurries comprising water-soluble polymers. Such two-phase systems are variously referred to in the literature as water-in-water emulsions, biphasic systems, aqueous two phase systems (ATPS), gelling polymer fluid, cross-linked microbeads, aqueous/aqueous emulsion system, aqueous biphasic system, low viscosity polymer fluid, filled system, solvent-in-solvent emulsion, or heterogeneous mixture (with a polymer rich phase and a partitioning agent rich phase). Although they may be referred to as emulsions they do not necessarily contain either oil or surfactant.

### Preparing a Composition

The method for combining the components can include the steps of mixing a Theological polymer, a partitioning agent, and a first liquid medium to form a heterogeneous mixture comprising a continuous crosslinkable polymer-rich phase and a dispersed partitioning agent-rich phase; then crosslinking the polymer in the continuous phase, and injecting the well treatment fluid into the well bore. For example, a mixture may use guar gum in solution with waxy maize starch. This water-in-water phase separation between guar and waxy maize starch has several applications within the oil field service industry.

A useful wellbore treatment fluid can be created by phase-separating the crosslinkable polymer in solution with a second material (possibly also a polymer) that does not participate in the crosslinking reaction or process. The crosslinkable polymer is then concentrated in its phase, and can be crosslinked in this volume even though globally the polymer concentration is well below the critical overlap concentration for crosslinking. Using this technique, crosslinked fluids can be formulated with a minimum amount of an expensive polymer or a limited amount of a damaging polymer.

### Ratio of Components

The ratio of components selected within the fluid or concentrate may be selected based on a variety of factors. In an embodiment, the mixing step comprises a weight ratio of Theological polymer to partitioning agent from 1:4 to 5:1. In another embodiment, the partitioning agent in the fluid is at a concentration of about 50 percent or more volume percent In an embodiment, the heterogeneous mixture can include from 5 to 20 percent of the Theological polymer, by weight of the water in the mixture. In another embodiment, the crosslinkable polymer in the fluid is at a concentration of about 0.01 to 5 weight percent. In another embodiment, the crosslinkable polymer in the fluid is at a concentration of less than 0.1 weight percent. In another embodiment, the crosslinker is at a concentration of about 0.01 to about 2.0 weight percent.

In an embodiment, the heterogeneous polymer concentrate can have any suitable weight ratio of crosslinkable polymer to partitioning agent that provides a heterogeneous mixture, i.e. a binary liquid mixture or a solid-liquid slurry. If the ratio of polymer:partitioning agent is too high, the mixture becomes too thick to pour or pump, or may even form a paste; if too low, the partitioning agent upon dilution may have an adverse impact on the polymer solution or well treatment fluid. Another embodiment of the present invention provides the polymer concentrate prepared by a method described above.

### Partitioning Agent

In an embodiment, partitioning agent is selected that severely limits the solubility of a theological agent, such as a crosslinkable polymer. As a result, the mixture forms a water-in-water emulsion where a concentrated theological agent is concentrated in continuous phase, of a viscous aqueous solution, and the partitioning agent is concentrated in the dispersed phase. One exemplary, non-limiting system comprises guar as the viscosifying agent and waxy-maize starch as the partioning agent.

The selection of the partitioning agent depends on the polymer that is to be concentrated in the heterogeneous mixture, as well as the solvent system, e.g. aqueous, non-aqueous, oil, etc. In one embodiment in general, the partitioning agent is soluble in the solvent medium, but has dissimilar thermodynamic properties such that a solution thereof is immiscible with a solution of the polymer at concentrations above a binodal curve for the system, or such that a solid phase of the polymer will not dissolve in a solution of the partioning agent at the concentration in the system. For example, where the polymer is a high molecular weight hydrophilic polymer, the partitioning agent can be a low molecular weight hydrophobic polymer. For guar and polymers thermodynamically similar to guar, the partitioning agent in an embodiment is a polyoxyalkylene, wherein the oxyalkylene units comprise from one to four carbon atoms, such as, for example a polymer of ethylene glycol, propylene glycol or oxide, or a combination thereof, having a weight average molecular weight from 1000 to 25,000. As used herein, “polyoxyalkylene” and refers to homopolymers and copolymers comprising at least one block, segment, branch or region composed of oxyalkylene repeat units, e.g. polyethylene glycol. Polyethylene glycol (PEG) having a molecular weight between 2000 and 10,000 is widely commercially available. Other embodiments comprise methoxy-PEG (mPEG); poloxamers available as PEG-polypropylene oxide (PPO) triblock copolymers under the trade designation PLURONICS™; alkylated and hydroxyalkylated PEG available under the trade designation BRIJ™, e.g. BRIJ 38™; and the like.

Other examples of partitioning agents can include polyvinyl pyrrolidone, vinyl pyrrolidine-vinyl acetate copolymers, and hydroxyalkylated or carboxyalkylated cellulose, especially low molecular weight hydroxyalkylated cellulose such as hydroxypropyl cellulose having a molecular weight of about 10,000.

Another embodiment of partitioning agents comprises the class of water soluble chemicals known as non-ionic surfactants. These surfactants comprise hydrophilic and hydrophobic groups, that is, they are amphiphilic, but are electrophilically neutral, i.e. uncharged. Nonionic surfactants can be selected from the group consisting of alkyl polyethylene oxides (such as BRIJ™ surfactants, for example), polyethylene oxide-polypropylene oxide copolymers (such as poloxamers or poloxamines, for example), alkyl-, hydroxyalkyl- and alkoxyalkyl polyglucosides (such as octyl or decyl glucosides or maltosides), fatty alcohols, fatty acid amides, and the like.

### Crosslinkable Polymer

As used herein, when a polymer is referred to as comprising a monomer or comonomer, the monomer is present in the polymer in the polymerized form of the monomer or in the derivative form of the monomer. However, for ease of reference the phrase comprising the (respective) monomer or the like may be used as shorthand.

Some examples of polymers useful in embodiments of the invention include polymers that are either crosslinked or linear, or any combination thereof. Polymers include natural polymers, derivatives of natural polymers, synthetic polymers, biopolymers, and the like, or any mixtures thereof. An embodiment uses any viscosifying polymer used in the oil industry to form gels. Another embodiment uses any friction-reducing polymer used in the oil industry to reduce friction pressure losses at high pumping rates, e.g. in SLICKWATER™ systems.

Useful gellable polymers include but are not limited to polymers that are either three dimensional or linear, or any combination thereof. Polymers include natural polymers, derivatives of natural polymers, synthetic polymers, biopolymers, and the like, or any mixtures thereof. Some nonlimiting examples of suitable polymers include guar gums, high-molecular weight polysaccharides composed of mannose and galactose sugars, or guar derivatives such as hydropropyl guar (HPG), carboxymethyl guar (CMG), and carboxymethylhydroxypropyl guar (CMHPG). Cellulose derivatives such as hydroxyethylcellulose (HEC) or hydroxypropylcellulose (HPC) and carboxymethylhydroxyethylcellulose (CMHEC) may also be used in either crosslinked form, or without crosslinker in linear form. Xanthan, diutan, and scleroglucan, three biopolymers, have been shown to be useful as well. Synthetic polymers such as, but not limited to, polyacrylamide, polyvinyl alcohol, polyethylene glycol, polypropylene glycol, and polyacrylate polymers, and the like, as well as copolymers thereof, are also useful. Also, associative polymers for which viscosity properties are enhanced by suitable surfactants and hydrophobically modified polymers can be used, such as cases where a charged polymer in the presence of a surfactant having a charge that is opposite to that of the charged polymer, the surfactant being capable of forming an ion-pair association with the polymer resulting in a hydrophobically modified polymer having a plurality of hydrophobic groups.

In some cases, the polymer, or polymers, include a linear, nonionic, hydroxyalkyl galactomannan polymer or a substituted hydroxyalkyl galactomannan polymer. Examples of useful hydroxyalkyl galactomannan polymers include, but are not limited to, hydroxy-C₁-C₄-alkyl galactomannans, such as hydroxy-C₁-C₄-alkyl guars. Preferred examples of such hydroxyalkyl guars include hydroxyethyl guar (HE guar), hydroxypropyl guar (HP guar), and hydroxybutyl guar (HB guar), and mixed C₂-C₄, C₂/C₃, C₃/C₄, or C₂/C₄ hydroxyalkyl guars. Hydroxymethyl groups can also be present in any of these.

As used herein, substituted hydroxyalkyl galactomannan polymers are obtainable as substituted derivatives of the hydroxy-C₁-C₄-alkyl galactomannans, which include: 1) hydrophobically-modified hydroxyalkyl galactomannans, e.g., C₁-C₂₄-alkyl-substituted hydroxyalkyl galactomannans, e.g., wherein the amount of alkyl substituent groups is preferably about 2% by weight or less of the hydroxyalkyl galactomannan; and 2) poly(oxyalkylene)-grafted galactomannans (see, e.g., A. Bahamdan & W. H. Daly, in Proc. 8th Polymers for Adv. Technol. Int'l Symp. (Budapest, Hungary, September 2005) (PEG- and/or PPG-grafting is illustrated, although applied therein to carboxymethyl guar, rather than directly to a galactomannan)). Poly(oxyalkylene)-grafts thereof can comprise two or more than two oxyalkylene residues; and the oxyalkylene residues can be C₁-C₄ oxyalkylenes. Mixed-substitution polymers comprising alkyl substituent groups and poly(oxyalkylene) substituent groups on the hydroxyalkyl galactomannan are also useful herein. In various embodiments of substituted hydroxyalkyl galactomannans, the ratio of alkyl and/or poly(oxyalkylene) substituent groups to mannosyl backbone residues can be about 1:25 or less, i.e. with at least one substituent per hydroxyalkyl galactomannan molecule; the ratio can be: at least or about 1:2000, 1:500, 1:100, or 1:50; or up to or about 1:50, 1:40, 1:35, or 1:30. Combinations of galactomannan polymers can also be used.

As used herein, galactomannans comprise a polymannose backbone attached to galactose branches that are present at an average ratio of from 1:1 to 1:5 galactose branches: mannose residues. Preferred galactomannans comprise a 1→4-linked β-D-mannopyranose backbone that is 1→6-linked to α-D-galactopyranose branches. Galactose branches can comprise from 1 to about 5 galactosyl residues; in various embodiments, the average branch length can be from 1 to 2, or from 1 to about 1.5 residues. Preferred branches are monogalactosyl branches. In various embodiments, the ratio of galactose branches to backbone mannose residues can be, approximately, from 1:1 to 1:3, from 1:1.5 to 1:2.5, or from 1:1.5 to 1:2, on average. In various embodiments, the galactomannan can have a linear polymannose backbone. The galactomannan can be natural or synthetic. Natural galactomannans useful herein include plant and microbial (e.g., fungal) galactomannans, among which plant galactomannans are preferred. In various embodiments, legume seed galactomannans can be used, examples of which include, but are not limited to: tara gum (e.g., from Cesalpinia spinosa seeds) and guar gum (e.g., from Cyamopsis tetragonoloba seeds). In addition, although embodiments of the present invention may be described or exemplified with reference to guar, such as by reference to hydroxy-C₁-C₄-alkyl guars, such descriptions apply equally to other galactomannans, as well.

In embodiments, the rheological polymer can be a polysaccharide; the partitioning agent a polyalkylene oxide. In a particular embodiment, the heterogeneous mixture can comprise polyethylene glycol and one or more of guar, guar derivative, cellulose, cellulose derivative, heteropolysaccharide, heteropolysaccharide derivative, or polyacrylamide in an aqueous medium.

### Additional Fluid Components

In an embodiment, the liquid media can be aqueous and the partitioning agent can include nonionic surfactant. Additionally or alternatively, the method can further comprise the step of dispersing a gas phase in the well treatment fluid to form an energized fluid or foam.

The water-in-water emulsion may further include other additives such as dispersing aids, surfactants, pH adjusting compounds, buffers, antioxidants, colorants, biocides, which do not materially change the miscibility or solubility of the heterogeneous phases, or interfere with the desirable characteristics of the well treatment fluid. The polymer concentrate can include any additive that is to be introduced into the well treatment fluid separately, provided that it is essentially inert in the concentrate. In one embodiment, at least one other well treatment fluid additive is present in the polymer concentrate, such as, for example, proppants, fibers, crosslinkers, breakers, breaker aids, friction reducers, surfactants, clay stabilizers, buffers, and the like. The other additive can also be concentrated in the polymer concentrate so that the additive does not need to be added to the well treatment fluid separately, or can be added in a lesser amount. This can be advantageous where the other additive is usually added proportionally with respect to the polymer. Also, the activity of an additive(s) can be delayed, in one embodiment, and the delay can at least in part be facilitated where the additive is preferentially concentrated in the partitioning agent-rich phase or otherwise reactively separated from the polymer.

Some fluid compositions useful in some embodiments of the invention may also include a gas component, produced from any suitable gas that forms an energized fluid or foam when introduced into an aqueous medium. See, for example, U.S. Pat. No. 3,937,283 (Blauer, et al.) incorporated herein by reference. Preferably, the gas component comprises a gas selected from the group consisting of nitrogen, air, argon, carbon dioxide, and any mixtures thereof. More preferably the gas component comprises nitrogen or carbon dioxide, in any quality readily available. The gas component may assist in the fracturing and acidizing operation, as well as the well clean-up process.

The fluid in one embodiment may contain from about 10% to about 90% volume gas component based upon total fluid volume percent, preferably from about 20% to about 80% volume gas component based upon total fluid volume percent, and more preferably from about 30% to about 70% volume gas component based upon total fluid volume percent. In one embodiment, the fluid is a high-quality foam comprising 90 volume percent or greater gas phase. In one embodiment, the partitioning agent used in the polymer delivery system can be selected to enhance the characteristics of the energized fluid or foam, such as gas phase stability or viscosity, for example, where the partitioning agent is a surfactant such as a nonionic surfactant, especially the alkoxylated (e.g., ethoxylated) surfactants available under the BRIJ™ designation.

In some embodiments, the fluids used may further include a crosslinker. Adding crosslinkers to the fluid may further augment the viscosity of the fluid. Crosslinking consists of the attachment of two polymeric chains through the chemical association of such chains to a common element or chemical group. Suitable crosslinkers may comprise a chemical compound containing a polyvalent ion such as, but not necessarily limited to, boron or a metal such as chromium, iron, aluminum, titanium, antimony and zirconium, or mixtures of polyvalent ions. The crosslinker can be delayed, in one embodiment, and the delay can at least in part be facilitated where the crosslinker or activator is concentrated or otherwise reactively separated in the partitioning agent-rich phase.

### Apparatus

A means of mixing a two-phase concentrate and selectively crosslinking one phase to make a water water emulsion includes a continuous stirred tank reactor or a batch vessel that is configured to provide a fluid with a pH of about 8 or higher.

A further embodiment of the invention provides a method for supplying a hydrated polymer solution. The method can include the steps of: (a) supplying theological polymer solids, a partitioning agent and a first aqueous stream to a mixing zone to form a water-in-water emulsion stream; (b) optionally mechanically, thermally or mechanically and thermally processing the water-in-water emulsion stream to improve hydratability of the theological polymer; and (c) supplying the water-in-water emulsion stream with a second aqueous stream to a dilution zone to form a theologically modified aqueous stream.

In the fracturing treatment, fluids of the invention may be used in the pad treatment, the proppant stage, or both. The components of the liquid phase are preferably mixed on the surface. Alternatively, a the fluid may be prepared on the surface and pumped down tubing while the gas component could be pumped down the annular to mix down hole, or vice versa.

Yet another embodiment of the invention includes cleanup method. The term “cleanup” or “fracture cleanup” refers to the process of removing the fracture fluid (without the proppant) from the fracture and wellbore after the fracturing process has been completed. Techniques for promoting fracture cleanup traditionally involve reducing the viscosity of the fracture fluid as much as practical so that it will more readily flow back toward the wellbore. While breakers are typically used in cleanup, the fluids of the invention may be effective for use in cleanup operations, with or without a breaker.

In another embodiment, the invention relates to gravel packing a wellbore. A gravel packing fluid, it preferably comprises gravel or sand and other optional additives such as filter cake clean up reagents such as chelating agents referred to above or acids (e.g. hydrochloric, hydrofluoric, formic, acetic, citric acid) corrosion inhibitors, scale inhibitors, biocides, leak-off control agents, among others. For this application, suitable gravel or sand is typically having a mesh size between 8 and 70 U.S. Standard Sieve Series mesh.

The procedural techniques for pumping fracture stimulation fluids down a wellbore to fracture a subterranean formation are well known. The person that designs such fracturing treatments is the person of ordinary skill to whom this disclosure is directed. That person has available many useful tools to help design and implement the fracturing treatments, one of which is a computer program commonly referred to as a fracture simulation model (also known as fracture models, fracture simulators, and fracture placement models). Most if not all commercial service companies that provide fracturing services to the oilfield have one or more fracture simulation models that their treatment designers use. One commercial fracture simulation model that is widely used by several service companies is known as FRACCADE™. This commercial computer program is a fracture design, prediction, and treatment-monitoring program designed by Schlumberger, Ltd., of Sugar Land, Tex. All of the various fracture simulation models use information available to the treatment designer concerning the formation to be treated and the various treatment fluids (and additives) in the calculations, and the program output is a pumping schedule that is used to pump the fracture stimulation fluids into the wellbore. The text “Reservoir Stimulation,” Third Edition, Edited by Michael J. Economides and Kenneth G. Nolte, Published by John Wiley & Sons, (2000), is a reference book for fracturing and other well treatments; it discusses fracture simulation models in Chapter 5 (page 5-28) and the Appendix for Chapter 5 (page A-15)), which are incorporated herein by reference.

### Additional Considerations

The fluids of some embodiments of the invention may include an electrolyte which may be an organic acid, organic acid salt, organic salt, or inorganic salt. Mixtures of the above members are specifically contemplated as falling within the scope of the invention. This member will typically be present in a minor amount (e.g. less than about 30% by weight of the liquid phase). The organic acid is typically a sulfonic acid or a carboxylic acid, and the anionic counter-ion of the organic acid salts is typically a sulfonate or a carboxylate. Representative of such organic molecules include various aromatic sulfonates and carboxylates such as p-toluene sulfonate, naphthalene sulfonate, chlorobenzoic acid, salicylic acid, phthalic acid and the like, where such counter-ions are water-soluble. Most preferred organic acids are formic acid, citric acid, 5-hydroxy-1-napthoic acid, 6-hydroxy-1-napthoic acid, 7-hydroxy-1-napthoic acid, 1-hydroxy-2-naphthoic acid, 3-hydroxy-2-naphthoic acid, 5-hydroxy-2-naphthoic acid, 7-hydroxy-2-napthoic acid, 1,3-dihydroxy-2-naphthoic acid, and 3,4-dichlorobenzoic acid.

The inorganic salts that are particularly suitable include, but are not limited to, water-soluble potassium, sodium, and ammonium salts, such as potassium chloride and ammonium chloride. Additionally, magnesium chloride, calcium chloride, calcium bromide, zinc halide, sodium carbonate, and sodium bicarbonate salts may also be used. Any mixtures of the inorganic salts may be used as well. The inorganic salts may aid in the development of increased viscosity that is characteristic of preferred fluids. Further, the inorganic salt may assist in maintaining the stability of a geologic formation to which the fluid is exposed. Formation stability and in particular clay stability (by inhibiting hydration of the clay) is achieved at a concentration level of a few percent by weight and as such the density of fluid is not significantly altered by the presence of the inorganic salt unless fluid density becomes an important consideration, at which point, heavier inorganic salts may be used. In some embodiments of the invention, the electrolyte is an organic salt such as tetramethyl ammonium chloride, or inorganic salt such as potassium chloride. The electrolyte is preferably used in an amount of from about 0.01 wt % to about 12.0 wt % of the total liquid phase weight, and more preferably from about 0.1 wt % to about 8.0 wt % of the total liquid phase weight.

Fluids used in some embodiments of the invention may also comprise an organoamino compound. Examples of suitable organoamino compounds include, but are not necessarily limited to, tetraethylenepentamine, triethylenetetramine, pentaethylenehexamine, triethanolamine, and the like, or any mixtures thereof. When organoamino compounds are used in fluids of the invention, they are incorporated at an amount from about 0.01 wt % to about 2.0 wt % based on total liquid phase weight. Preferably, when used, the organoamino compound is incorporated at an amount from about 0.05 wt % to about 1.0 wt % based on total liquid phase weight. A particularly useful organoamino compound is tetraethylenepentamine, particularly when used with diutan viscosifying agent at temperatures of approximately 300° F.

Breakers may optionally be used in some embodiments of the invention. The purpose of this component is to “break” or diminish the viscosity of the fluid so that this fluid is even more easily recovered from the formation during cleanup. With regard to breaking down viscosity, oxidizers, enzymes, or acids may be used. Breakers reduce the polymer's molecular weight by the action of an acid, an oxidizer, an enzyme, or some combination of these on the polymer itself. In the case of borate-crosslinked gels, increasing the pH and therefore increasing the effective concentration of the active crosslinker (the borate anion), will allow the polymer to be crosslinked. Lowering the pH can just as easily eliminate the borate/polymer bonds. At pH values at or above 8, the borate ion exists and is available to crosslink and cause gelling. At lower pH, such as a pH of about 6 or lower, the borate is tied up by hydrogen and is not available for crosslinking, thus gelation caused by borate ion is reversible. Preferred breakers include 0.1 to 20 pounds per thousands gallons of conventional oxidizers such as ammonium persulfates, live or encapsulated, or potassium periodate, calcium peroxide, chlorites, and the like. In oil producing formations the film may be at least partially broken when contacted with formation fluids (oil), which may help de-stabilize the film. The breaker can be delayed, in one embodiment, and the delay can at least in part be facilitated where the breaker or breaker activator is concentrated or otherwise reactively separated in the partitioning agent-rich phase.

A fiber component may be included in the fluids used in the invention to achieve a variety of properties including improving particle suspension, and particle transport capabilities, and gas phase stability. Fibers used may be hydrophilic or hydrophobic in nature, but hydrophilic fibers are preferred. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON™ polyethylene terephthalate (PET) Fibers available from Invista Corp. of Wichita, Kans., USA, 67220. Other examples of useful fibers include, but are not limited to, polylactic acid polyester fibers, polyglycolic acid polyester fibers, polyvinyl alcohol fibers, and the like. When used in fluids of the invention, the fiber component may be included at concentrations from about 1 to about 15 grams per liter of the liquid phase of the fluid, preferably the concentration of fibers are from about 2 to about 12 grams per liter of liquid, and more preferably from about 2 to about 10 grams per liter of liquid.

Embodiments of the invention may use other additives and chemicals that are known to be commonly used in oilfield applications by those skilled in the art. These include, but are not necessarily limited to, materials in addition to those mentioned hereinabove, such as breaker aids, oxygen scavengers, alcohols, scale inhibitors, corrosion inhibitors, fluid-loss additives, bactericides, iron control agents, organic solvents, and the like. Also, they may include a co-surfactant to optimize viscosity or to minimize the formation of stabilized emulsions that contain components of crude oil, or as described hereinabove, a polysaccharide or chemically modified polysaccharide, natural polymers and derivatives of natural polymers, such as cellulose, derivatized cellulose, guar gum, derivatized guar gum, or biopolymers such as xanthan, diutan, and scleroglucan, synthetic polymers such as polyacrylamides and polyacrylamide copolymers, oxidizers such as persulfates, peroxides, bromates, chlorates, chlorites, periodates, and the like. Some examples of organic solvents include ethylene glycol monobutyl ether, isopropyl alcohol, methanol, glycerol, ethylene glycol, mineral oil, mineral oil without substantial aromatic content, and the like.

Embodiments of the invention may also include placing proppant particles that are substantially insoluble in the fluids. Proppant particles carried by the treatment fluid remain in the fracture created, thus propping open the fracture when the fracturing pressure is released and the well is put into production. Suitable proppant materials include, but are not limited to, sand, walnut shells, sintered bauxite, glass beads, ceramic materials, naturally occurring materials, or similar materials. Mixtures of proppants can be used as well. If sand is used, it will typically be from about 20 to about 100 U.S. Standard Mesh in size. Naturally occurring materials may be underived and/or unprocessed naturally occurring materials, as well as materials based on naturally occurring materials that have been processed and/or derived. Suitable examples of naturally occurring particulate materials for use as proppants include, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc. including such woods that have been processed by grinding, chipping, or other form of particalization, processing, etc. Further information on nuts and composition thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference.

The concentration of proppant in the fluid can be any concentration known in the art, and will preferably be in the range of from about 0.05 to about 3 kilograms of proppant added per liter of liquid phase. Also, any of the proppant particles can further be coated with a resin to potentially improve the strength, clustering ability, and flow back properties of the proppant.

Conventional propped hydraulic fracturing techniques, with appropriate adjustments if necessary, as will be apparent to those skilled in the art, are used in some methods of the invention. One preferred fracture stimulation treatment according to the present invention typically begins with a conventional pad stage to generate the fracture, followed by a sequence of stages in which a viscous carrier fluid transports proppant into the fracture as the fracture is propagated. Typically, in this sequence of stages the amount of propping agent is increased, normally stepwise. The pad and carrier fluid can be a fluid of adequate viscosity. The pad and carrier fluids may contain various additives. Non-limiting examples are fluid loss additives, crosslinking agents, clay control agents, breakers, iron control agents, and the like, provided that the additives do not affect the stability or action of the fluid.

Embodiments of the invention may use other additives and chemicals that are known to be commonly used in oilfield applications by those skilled in the art. These include, but are not necessarily limited to, materials in addition to those mentioned hereinabove, such as breaker aids, oxygen scavengers, alcohols, scale inhibitors, corrosion inhibitors, fluid-loss additives, bactericides, iron control agents, organic solvents, and the like. Also, they may include a co-surfactant to optimize viscosity or to minimize the formation of stabilized emulsions that contain components of crude oil, or as described hereinabove, a polysaccharide or chemically modified polysaccharide, natural polymers and derivatives of natural polymers, such as cellulose, derivatized cellulose, guar gum, derivatized guar gum, or biopolymers such as xanthan, diutan, and scleroglucan, synthetic polymers such as polyacrylamides and polyacrylamide copolymers, oxidizers such as persulfates, peroxides, bromates, chlorates, chlorites, periodates, and the like. Some examples of organic solvents include ethylene glycol monobutyl ether, isopropyl alcohol, methanol, glycerol, ethylene glycol, mineral oil, mineral oil without substantial aromatic content, and the like.

### EXAMPLES

The following examples are presented to illustrate the preparation and properties of fluid systems, and should not be construed to limit the scope of the invention, unless otherwise expressly indicated in the appended claims. All percentages, concentrations, ratios, parts, etc. are by weight unless otherwise noted or apparent from the context of their use.

A series of solutions were made from mixtures of high molecular weight guar gum supplied from Rhodia, with molecular weight of about 2 million and a waxy-maize starch supplied from National Starch of Houston, Tex. The waxy-maize material has been selected to be almost entirely amylopectin. The waxy-maize material was chosen as a pre-cooked sample to obviate the need for heating the material to achieve dissolution in water.

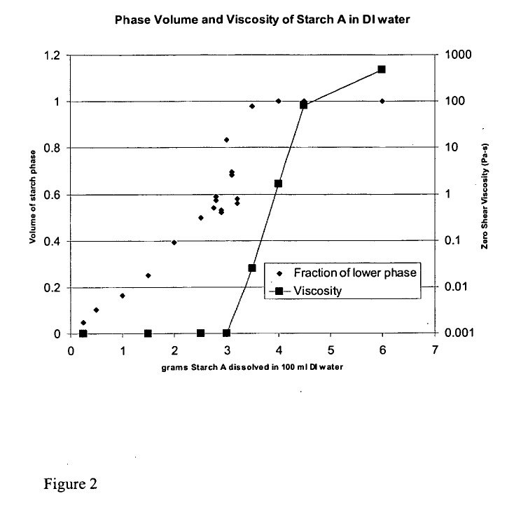

Initial lab testing showed that this waxy-maize starch creates a two-phase system when dissolved in water even without the presence of a second biopolymer. FIG. 2 shows the volumetric portion and zero-shear viscosity of a sample occupied by the starch-rich phase as a function of the amount of waxy-maize starch added. “Starch A” in FIG. 2 is a commercial product sample of ULTRASPERSE™ food starch available from National Starch.

As illustrated in FIG. 2, addition of the waxy maize starch provides no thickening or viscosifying effect until the amount of starch added exceeds approximately 3 percent. For starch concentrations below this level, however, the swollen starch granules do occupy a significant amount of space in the solution. The space filled by these swollen granules is not available for other polymers such as guar, thereby causing any added guar to be concentrated in the remaining volume.

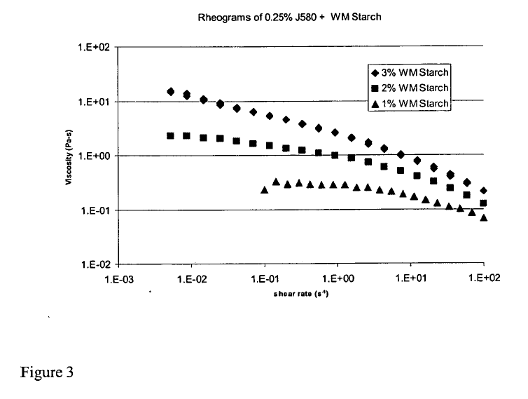

FIG. 3 illustrates the effect of the presence of the swollen waxy-maize starch on the viscosity of a guar solution. FIG. 3 shows the impact of adding up to 3% waxy-maize starch to a solution of 0.25% guar in water. The guar concentration in each case is held constant at 0.25 percent, but the amount of waxy-maize starch mixed in with the guar is increased from 0 percent to 3 percent. In spite of the fact that this concentration of starch would be expected to have no discernable impact on the fluid viscosity (as shown in FIG. 2), the viscosity of the combined starch and guar formulation increases strongly with starch addition.

The rheology shown in FIG. 3 demonstrates that addition of waxy maize starch to a guar solution unexpectedly increases the viscosity much more than would be expected from the viscosity of the starch solution. Presumably this results from concentrating the guar polymer in the available volume not occupied by the swollen starch. The most interesting result, though, arises when a borate crosslinker package is added to the guar-starch mixture. Solutions of waxy-maize starch at any concentration have not been found in the lab to be crosslinkable through addition of borate crosslinker. That is, the apparent viscosity of the starch solution has not been found to change with addition of borate chemistry. Guar in solution, of course, is well known to crosslink with addition of borate chemistry at pH greater than about 8.

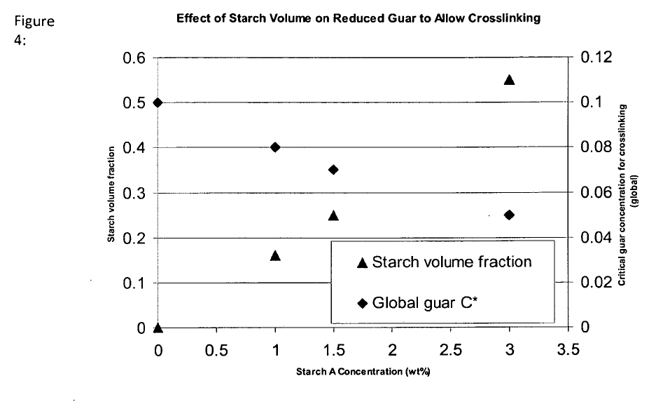

To explore the effects of having a second phase of swollen starch particles, a series of fluids were formulated with different ratios of guar and starch present. For each combination having shown the effect of starch addition on the rheology of non-crosslinked guar, the next part of the experimentation evaluated the effect on a crosslinked system. The presence of the swollen starch particles is successful in concentrating the guar polymer in continuous phase of the two-phase region, it is possible to crosslink the fluid at a lower guar concentration than what one would normally expect for guar in solution. A series of fluids were made to confirm this idea. For guar concentrations ranging from 0.01 percent to 0.5 percent, different amounts of waxy-maize starch were added, and a standard borate crosslinker package was added to each sample. (The fluid pH was increased to a pH between 10 and 10.5 by the addition of NaOH. After the pH adjustment a dilute solution of boric acid (3.5 weight percent boric acid in DI water) was added at a concentration of 1.4 ml per 100 ml of polymer solution). In this way, the minimum amount of guar required to achieve a crosslinked fluid was established for formulations with different amounts of waxy-maize starch. FIG. 4 presents a summary of the results in terms of minimum guar concentration to create a crosslinked fluid for waxy-maize starch concentrations ranging from 0 percent to 3 percent. (Note: the criterion for successful crosslinking was the presence of a visible hanging lip when a fluid sample was poured from a 100 ml beaker).

FIG. 4 illustrates that the presence of waxy-maize starch concentrates the guar polymer into only a portion of the total fluid volume. That is, FIG. 4 shows the minimum guar concentration to create a crosslinked fluid as a function of amount of added waxy-maize starch. The concentrated guar polymer can be crosslinked to create a crosslinked fluid with globally much reduced guar concentration. In this example, the presence of 3 percent waxy-maize starch is expected to fill approximately 50 percent of the total fluid volume (results shown in FIG. 1), and thereby double the effective guar concentration in the remaining volume. FIG. 4 indicates that this has, in fact, occurred since the critical guar concentration to achieve a crosslinked fluid has dropped in half for this condition.

The particular embodiments disclosed above are illustrative only, as the invention may be modified and practiced in different but equivalent manners apparent to those skilled in the art having the benefit of the teachings herein. Furthermore, no limitations are intended to the details herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A method of forming a fluid for use within in a subterranean formation, comprising:
combining a partitioning agent, crosslinkable polymer, and crosslinker into a fluid, wherein more than 50 percent of the crosslinkable polymer crosslinks and less than 10 percent of the partitioning agent crosslinks; and
introducing the fluid into the subterranean formation.

2. The method of claim 1, wherein the crosslinkable polymer is guar.

3. The method of claim 1, wherein the partitioning agent is waxy maize starch.

4. The method of claim 1, wherein the crosslinker is borate.

5. The method of claim 1, further comprising a chemical agent

6. The method of claim 5, wherein the chemical agent is a breaker.

7. The method of claim 6, wherein the breaker releases an agent to lower a fluid pH to about 6.0 or lower.

8. The method of claim 1, wherein the introducing the crosslinkable polymer, partitioning agent, and crosslinker is performed at a pH to encourage the crosslinkable polymer to crosslink and isolate from the partitioning agent.

9. The method of claim 8, wherein the pH is 8.0 or higher.

10. The method of claim 9, wherein the crosslinked crosslinkable polymer deforms upon exposure to the fluid with pH of about 6.0 or lower.

11. A method of forming a fluid for use within a subterranean formation, comprising:
combining a partitioning agent, crosslinkable polymer, and crosslinker into a fluid, wherein a critical polymer concentration for crosslinking the crosslinkable polymer is lower than if the partitioning agent were not in the fluid; and
introducing the fluid into the subterranean formation.

12. The method of claim 11, wherein the crosslinkable polymer in the fluid is at a concentration of about 0.01 to 5 weight percent.

13. The method of claim 11, wherein the crosslinkable polymer in the fluid is at a concentration of less than 0.1 weight percent.

14. The method of claim 11, wherein the crosslinker is at a concentration of about 0.01 to about 2.0 weight percent.

15. The method of claim 11, wherein the partitioning agent in the fluid is at a concentration of about 50 percent or more volume percent.

16. The method of claim 11, wherein more than 50 percent of the crosslinkable polymer crosslinks and less than 10 percent of the partitioning agent crosslinks.

17. The method of claim 11, wherein the introducing the crosslinkable polymer, partitioning agent, and crosslinker is performed at a pH to encourage the crosslinkable polymer to crosslink and isolate from the partitioning agent.

18. The method of claim 17, wherein the pH is 8.0 or higher.

19. The method of claim 11, wherein the crosslinkable polymer is guar.

20. The method of claim 11, wherein the partitioning agent is waxy maize starch.

21. The method of claim 11, wherein the crosslinker is borate.
